(19) United States
(12) Patent Application Publication
(10) Pub. No.: US 2016/0115373 A1
(43) Pub. Date: Apr. 28, 2016

(54) Method for Improving Guar Hydration

(71) Applicant: Ethox Chemicals, LLC, Greenville, SC (US)

(72) Inventors: William C. Floyd, III, Greenville, SC (US); Charles F. Palmer, JR., Greenville, SC (US)

(21) Appl. No.: 14/924,366

(22) Filed: Oct. 27, 2015

Related U.S. Application Data
(60) Provisional application No. 62/069,778, filed on Oct. 28, 2014.

(51) Int. Cl. C09K 8/68; C09K 8/88; E21B 43/26; C09K 8/90

(52) U.S. Cl. CPC C09K 8/68; C09K 8/905; C09K 8/885; E21B 43/26

(57) ABSTRACT

Improvements in hydraulic fracturing are provided in a hydraulic fracturing solution comprising water; a hydratable polysaccharide; and a wetting agent selected from the group consisting of:

R¹—O—(R²)ₓ—R³

wherein:
R¹ is a linear or branched alkyl chain of 6-25 carbons, an aryl moiety or combinations thereof;
each R² is independently selected from a polyalkoxylene of the structure —CH₂CH(R⁴)O—,
where R⁴ is independently H or C1-C4 alkyl chain, R³ is a terminal group; and
x is an integer of 1-9.

### CROSS-REFERENCE TO RELATED APPLICATIONS

The present invention claims priority to pending U.S. Provisional Patent Appl. No. 62/069,778 filed Oct. 28, 2014 which is incorporated herein by reference.

### BACKGROUND

The present invention is related to improvements in hydraulic fracturing operations and, more specifically, the present invention is related to improvements in rapidly hydrating hydratable polysaccharides, particularly guar, and the use of the rapidly hydrated polysaccharide as a thickening agent used to transport proppants into well formations.

The use of guar, and other hydratable polysaccharides, as thickening agents in hydraulic fracturing operations is well known in the industry. These thickening agents improve transport of proppants into well formations. Before use the guar, also referred to as guar gum, must be hydrated and the solution viscosity must be increased to an acceptable level. The hydration typically takes an excessive amount of time for full viscosity build, thereby decreasing the overall effectiveness of the fracturing operation. There is a need for a method for accelerated hydration of guar, and other hydratable polysaccharides, to eliminate the waiting periods normally required to achieve the desired viscosity. This is especially true for operations where guar is added to water on site in response to real time conditions observed in the well or “on the fly” operations. Additionally, under many circumstances such as cold environmental conditions additional costs are encountered due to the necessity to heat the water used for polymer hydration.

There has been a long standing need for improvements in guar hydration and improvements in fracturing provided thereby.

### SUMMARY OF THE INVENTION

It is an object of the invention to provide an improved method for hydrating polysaccharides, particularly guar, by treatment with a wetting agent or nonionic surfactant formulation.

It is another object of the invention to provide a fracturing solution which is easily prepared on-site with rapid viscosity build.

It is another object of the invention to provide an improvement in hydraulic fracturing, particularly when hydraulic fracturing is required within a short time.

A particular feature of the invention is the ability to hydrate hydratable polysaccharides, particularly guar, in less time thereby mitigating inefficiencies in the art of fracturing.

Yet another advantage provides for a method to more rapidly and efficiently provide a thickened aqueous solution for friction reduction and/or proppant transport in a well, especially at lower temperatures where preheating the water would otherwise be necessary.

Yet another advantage is the ability to accelerate the hydration of guar polymers at low temperatures such as at temperatures of below 15° C.

These, and other advantages as will be realized, are provided in a hydraulic fracturing solution comprising water; a hydratable polysaccharide; and a wetting agent selected from the group consisting of:

R¹—O—(R²)ₓ—R³

wherein:
R¹ is a linear or branched alkyl chain of 6-25 carbons, an aryl moiety or combinations thereof;
each R² is independently selected from a polyalkoxylene of the structure —CH₂CH(R⁴)O—,
where R⁴ is independently H or C1-C4 alkyl chain, R³ is a terminal group; and
x is an integer of 1-9.

Yet another embodiment is provided in a method for subterranean fracturing comprising:

forming a fracturing solution comprising a hydrated polysaccharide and a proppant comprising:
hydrating the hydratable polysaccharide with a hydrating solution to form a hydrated powder wherein the hydrating solution comprises:
water;
a hydratable polysaccharide;
a wetting agent selected from the group consisting of:

R¹—O—(R²)ₓ—R³

wherein:
R¹ is an alkyl 6-25 carbons, an aryl or combinations thereof;
each R² is independently selected from ethylene oxide, propylene oxide, or butylene oxide, in any order;
R³ is a terminal group; and
x is an integer of 1-9; and
pumping the fracturing solution into a well.

### FIGURES

FIG. 1 is a flow chart representation of an embodiment of the invention.

### DESCRIPTION

The instant invention is specific to improvements in the hydration of hydratable polysaccharides, and particularly guars, to improvements in hydraulic fracturing provided thereby.

The invention will be described with reference to the FIGURE forming an integral non-limiting component of the disclosure.

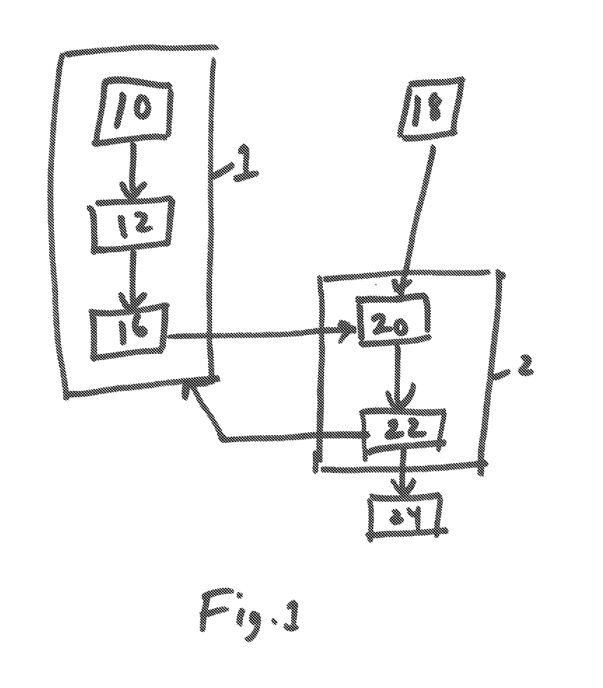

An embodiment of the invention will be described with reference to FIG. 1 wherein a process of hydrating powder, generally represented at 1, and fracturing a well, generally represented at 2, are illustrated in the form of a flow chart. In FIG. 1, a hydratable polysaccharide, preferably guar also referred to as guar gum, is provided at 10 as a powder. The powder is mixed with a hydrating solution at 12, and mixed to allow the hydrating solution to form hydrated powder and to rapidly build viscosity. The hydrating solution will be described further herein. It is preferable that the powder and hydrating solution be mixed for no more than 15 minutes, more preferably no more than 10 minutes, more preferable no more than 5 minutes and most preferably no more than 3 minutes while achieving a viscosity of at least 70% maximum viscosity and preferably at least 80% maximum viscosity. Below about 3 minutes the viscosity is insufficient and above about 15 minutes the benefits of accelerated hydration are mitigated.

With continued reference to FIG. 1, a proppant can be added, if desired, either as a solid to the powder, at 10, as part of the hydration solution or during the hydration, indicated at 12, or to the hydrated powder, indicated at 16. A fracturing solution is thereby obtained at 16 wherein the fracturing solution comprises hydrated powder and optional proppant. A well is drilled at 18 preferably either prior to or simultaneous with the formation of the fracturing solution. The fracturing solution is pumped into the well at 20 with sufficient pressure and rate to cause fracture formation or enhancement of existing fractures in the subterranean zone of the well. As would be understood to those of skill in the art the proppants assist by holding of the fractures open, functioning as a spacer, thereby forming flow channels around the proppant to enhance flow of the fluid or gas being extracted from the well. Pumping of the fluid or gas from the well continues at 22 until the operation is complete at 24 or additional powder hydration is accomplished at 1 for subsequent pumping into the well at 20.

Hydratable polysaccharides include anionically substituted galactomanan gums, guars and cellulose derivatives. Particularly suitable hydratable polysaccharides include anionically substituted guar gum, locust bean gum, guar gum derivatives, Karaya gum, carboxymethyl cellulose, carboxymethyl hydroxyethyl cellulose, and anionically substituted hydroxyethyl cellulose. More preferred hydratable polysaccharides include carboxymethyl guar, carboxyethyl guar, carboxymethyl hydroxypropyl guar, carboxyethyl guar, carboxymethyl hydroxypropyl guar and carboxymethyl hydroxyethyl cellulose. Specifically preferred hydratable polysaccharides include sulfated or sulfonated guars, cationic guars derivatized with agents such as 3-chloro-2-hydroxypropyl trimethylammonium chloride, synthetic polymers with anionic groups including polyvinyl acetate, polyacrylamides and poly-2-amino-2-methyl propane sulfonic acid.

The hydrating solution is primarily water comprising at 0.05 to 5 wt % hydratable polysaccharide and 0.001% to 1 wt % wetting agent and more preferably 0.8-0.12 wt % wetting agent. For the purposes of demonstration around 0.1 wt % wetting agent is exemplary. In one embodiment of the invention, a particularly preferred wetting agent is alcohol ethoxylates defined by Formula I:

R¹—O—(R²)ₓ—R³

wherein:
R¹ is a branched or linear alkyl chain of 6-25 carbons, an aryl moiety or combinations thereof; preferably R¹ is an alkyl of 8-16 carbons and more preferably an alkyl of 10-14 carbons; each R² is a polyalkoxylene of the structure —CH₂CH(R⁴)O—, where R⁴ is independently H or C1-C4 alkyl chain. R³ is a terminal group preferably selected from H or an alkyl chain of 1-5 carbons; and x is an integer of 1-9, more preferably 3-5 with about 4 being most preferred. Alternatively, the wetting agent may be based on an ethoxylated triglyceride; preferably a castor oil ethoxylate or a hydrogenated castor oil ethoxylate, or an ethoxylated and/or propoxylated styrenated phenol. The wetting agent has a preferred Draves wetting speed of less than 20 seconds at 25° C. and a preferred surface tension of less than 35 dyne/cm at 25° C. at 0.1 wt % concentration.

Particularly preferred wetting agents are selected from the group consisting of ethoxylated hexyl alcohol with 2 to 9 EO (ethylene oxide) groups, ethoxylated heptyl alcohol with 2 to 9 EO groups, ethoxylated octyl alcohol with 2 to 9 EO groups, ethoxylated nonyl alcohol with 2 to 9 EO groups, ethoxylated decyl alcohol with 2 to 9 EO groups, ethoxylated undecyl alcohol with 2 to 9 EO groups, ethoxylated dodecyl alcohol with 2 to 9 EO groups, ethoxylated tridecyl alcohol with 2 to 9 EO groups, ethoxylated tetradecyl alcohol with 2 to 9 EO groups, ethoxylated pentadecyl alcohol with 2 to 9 EO groups, ethoxylated hexadecyl alcohol with 2 to 9 EO groups, ethoxylated heptadecyl alcohol with 2 to 9 EO groups, ethoxylated octadecyl alcohol with 2 to 9 EO groups, ethoxylated nonadecyl alcohol with 2 to 9 EO groups, ethoxylated eicosyl alcohol with 2 to 9 EO groups, ethoxylated heneicosyl alcohol with 2 to 9 EO groups, ethoxylated docosyl alcohol with 2 to 9 EO groups, ethoxylated tricosyl alcohol with 2 to 9 EO groups, ethoxylated tetracosyl alcohol with 2 to 9 EO groups, ethoxylated pentacosyl alcohol with 2 to 9 EO groups and ethoxylated styrenated phenols.

The surfactant package used for enhanced hydration optionally comprises up to 20 wt % defoamer to accelerate the viscosity build of the hydration solution without the formation of excessive foaming. Particularly preferred defoamers are copolymers of ethylene oxide (EO) and propylene oxide (PO) with a molecular weight of at least 500 to no more than 6000 and more particularly at least 650. Particularly preferred are block copolymers of ethylene oxide and propylene oxide comprising no more than 50 wt % ethylene oxide. A block PO-EO-PO copolymer with no more than 15 wt % EO is particularly suitable. These copolymer defoamers may optionally have alkyl chain end groups on one or both terminal ends of the polymer.

For the purposes of the instant invention, maximum viscosity is essentially the highest viscosity achievable by the same formulation at 25° C. without the wetting agent or defoaming agent, which is easily determined by monitoring viscosity as a function of time until the viscosity essentially plateaus. A particular feature of the instant invention is the ability to rapidly achieve a functional viscosity at lower operating temperatures than typically achieved in the art. By way of example, the instant formulation can rapidly achieve a viscosity of at least 70% of maximum viscosity, and more preferably a viscosity of at least 80% of maximum viscosity at a temperature of above 0° C. no more than 20° C., more preferably no more than 15° C. and even more preferably at no more than 10° C. The instant formulation can achieve at least 70% of maximum viscosity, and more preferably a viscosity of at least 80% of maximum viscosity in no more than 20 minutes, more preferably no more than 15 minutes, even more preferably no more than 10 minutes, more preferably no more than 5 minutes and most preferably no more than 3 minutes. The combination of rapid viscosity built, achievable at temperatures below 10° C. provides a significant advantage since the fracturing solution can be prepared on site, even at low temperatures, without the necessity of heaters and the fracturing solution can be deployed within minutes of preparation.

The proppant are solid materials with a shape and size suitable to be transported into a well wherein the proppant enters the fissure, under pressure, and acts to form a separator between adjacent layers thereby allowing fluid to flow more freely. The material of the proppant are not particularly limited herein yet sand and ceramics are exemplary due to their availability and low cost.

The term alkyl; either generally or specifically such as ethyl, propyl, etc.; refers to straight chain alkyl or branched alkyl, substituted or unsubstituted alkyl, containing 2-40 carbons unless otherwise specified. The term aryl, either generally or specifically such as phenyl, naphthyl, etc. refers to substituted or unsubstituted aryl unless otherwise specified.

### EXAMPLES

### Control

A control sample was prepared by adding 10 g of KCl to 500 mL of water in a blender set to stir at 2000 rpm. The solution was stirred until the KCl dissolved after which a single portion of 2.5 g (0.5% or 5 gpt) of WG-111D grade guar powder obtained from Trican Well Service. Addition of the guar was defined as time zero. After one minute, stirring was stopped and approximately 100 mL of the sample were transferred to a Brookfield DVE rheometer equipped with a s62 spindle at factory recommended RPM. The viscosity of the solution was measured at room temperature. The viscosity as a function of time is reproduced in the table below.

### Inv. 1

The control experiment was repeated with the exception of the addition of 0.5 g (0.1%) of ethoxylated dodecyl alcohol of formula CH₃(CH₂)₁₀CH₂(OCH₂CH₂)₄₃OH (designated A) as a wetting agent (WA) added to the water before the addition of the guar. The viscosities were recorded as a function of time at room temperature with the results presented in the table below.

### Inv. 2

Inv. 1 was repeated with the exception of the addition of 0.05 g of a PO-EO-PO block polymer (designated B) having about 10 wt % EO and a molecular weight of about 4,000 available from Ethox Chemicals as 31-R-1 as the defoamer (DF) added to the water before addition of guar. The viscosities were measured as a function of time at room temperature with the results presented in the table below

TABLE

| Sample | WA | DF | Time (Min.) | Viscosity |
|---|---|---|---|---|
| Control | — | — | 3 | 156 |
| Control | — | — | 5 | 239 |
| Control | — | — | 15 | 340 |
| Control | — | — | 30 | 376 |
| Control | — | — | 60 | 397 |
| Inv. 1 | A | — | 3 | 267 |
| Inv. 1 | A | — | 5 | 332 |
| Inv. 1 | A | — | 15 | 608 |
| Inv. 1 | A | — | 30 | 668 |
| Inv. 2 | A | B | 1 | 356 |
| Inv. 2 | A | B | 3 | 458 |
| Inv. 2 | A | B | 15 | 607 |
| Inv. 2 | A | B | 30 | 646 |
| Inv. 2 | A | B | 60 | 650 |

These experiments demonstrate that a guar solution will build viscosity much more rapidly in the presence of a wetting agent, especially in the presence of a defoamer. The control reaches a viscosity of only 397 cP after 1 hour which is less than about 70% maximum viscosity. Inv. 1 reaches 70% maximum viscosity, which is approximately 668 cP, at less than 15 minutes and 80% maximum viscosity at less than 15 minutes. Inv. 2 reaches 70% maximum viscosity, which is approximately 650 cP, at less than 3 minutes and 80% of maximum viscosity at less than 15 minutes.

The invention has been described with reference to the preferred embodiments without limit thereto. One of skill in the art would realize additional embodiments and improvements which are not specifically set forth herein but which are within the scope of the invention as more specifically set forth in the claims appended hereto.

Claimed is:

1. A hydraulic fracturing solution comprising:
water;
a hydratable polysaccharide; and
a wetting agent selected from the group consisting of:
R¹—O—(R²)ₓ—R³
wherein:
R¹ is a linear or branched alkyl chain of 6-25 carbons, an aryl moiety or combinations thereof;
each R² is independently selected from a polyalkoxylene of the structure —CH₂CH(R⁴)O—, where R⁴ is independently H or C1-C4 alkyl chain;
R³ is a terminal group; and
x is an integer of 1-9.

2. The hydraulic fracturing solution of claim 1 further comprising a proppant.

3. The hydraulic fracturing solution of claim 1 wherein said hydratable polysaccharide is selected from the group consisting of anionically substituted galactomannan gum, guar and a cellulose derivative.

4. The hydraulic fracturing solution of claim 3 wherein said hydratable polysaccharide is guar.

5. The hydraulic fracturing solution of claim 3 wherein said hydratable polysaccharide is selected from the group consisting of anionically substituted guar gum, locust bean gum, guar gum derivatives, Karaya gum, carboxymethyl cellulose, carboxymethyl hydroxyethyl cellulose, and anionically substituted hydroxyethyl cellulose.

6. The hydraulic fracturing solution of claim 3 wherein said hydratable polysaccharide is selected from the group consisting of carboxymethyl guar, carboxyethyl guar, carboxymethyl hydroxypropyl guar, carboxyethyl guar, carboxymethyl hydroxypropyl guar and carboxymethyl hydroxyethyl cellulose.

7. The hydraulic fracturing solution of claim 3 wherein said hydratable polysaccharide is selected from the group consisting of sulfated or sulfonated guars, derivatized cationic guars, synthetic polymers with anionic groups.

8. The hydraulic fracturing solution of claim 1 wherein said hydratable polysaccharide is selected from the group consisting of polyvinyl acetate, polyacrylamides and poly-2-amino-2-methyl propane sulfonic acid

9. The hydraulic fracturing solution of claim 1 wherein R¹ is an alkyl of 8-16 carbons.

10. The hydraulic fracturing solution of claim 9 wherein R¹ is an alkyl of 10-14 carbons.

11. The hydraulic fracturing solution of claim 1 wherein R³ is selected from H, an alkyl of 1-5 carbons or an aryl.

12. The hydraulic fracturing solution of claim 1 wherein x is an integer of 3-5.

13. The hydraulic fracturing solution of claim 1 wherein wetting agent is selected from the group consisting of ethoxylated hexyl alcohol with 2 to 9 EO groups, ethoxylated heptyl alcohol with 2 to 9 EO groups, ethoxylated octyl alcohol with 2 to 9 EO groups, ethoxylated nonyl alcohol with 2 to 9 EO groups, ethoxylated decyl alcohol with 2 to 9 EO groups, ethoxylated undecyl alcohol with 2 to 9 EO groups, ethoxylated dodecyl alcohol with 2 to 9 EO groups, ethoxylated tridecyl alcohol with 2 to 9 EO groups, ethoxylated tetradecyl alcohol with 2 to 9 EO groups, ethoxylated pentadecyl alcohol with 2 to 9 EO groups, ethoxylated hexadecyl alcohol with 2 to 9 EO groups, ethoxylated heptadecyl alcohol with 2 to 9 EO groups, ethoxylated octadecyl alcohol with 2 to 9 EO groups, ethoxylated nonadecyl alcohol with 2 to 9 EO groups, ethoxylated eicosyl alcohol with 2 to 9 EO groups, ethoxylated heneicosyl alcohol with 2 to 9 EO groups, ethoxylated docosyl alcohol with 2 to 9 EO groups, ethoxylated tricosyl alcohol with 2 to 9 EO groups, ethoxylated tetracosyl alcohol with 2 to 9 EO groups, ethoxylated pentacosyl alcohol with 2 to 9 EO groups and ethoxylated syrenated phenols.

14. The hydraulic fracturing solution of claim 1 further comprising a triglyceride.

15. The hydraulic fracturing solution of claim 14 wherein said triglyceride is selected from a castor oil ethoxylate or a hydrogenated castor oil ethoxylate.

16. The hydraulic fracturing solution of claim 1 further comprising a defoaming agent.

17. The hydraulic fracturing solution of claim 16 comprising up to 0.10 wt % of said defoaming agent.

18. The hydraulic fracturing solution of claim 16 wherein said defoaming agent is a polymer comprising at least one of polyethylene oxide or polypropylene oxide.

19. The hydraulic fracturing solution of claim 18 wherein said defoaming agent has a molecular weight of at least 500 to no more than 6000.

20. The hydraulic fracturing solution of claim 18 wherein said defoaming agent is a block copolymer.

21. A method for subterranean fracturing comprising:
forming a fracturing solution comprising a hydrated polysaccharide and a proppant comprising:
hydrating said hydratable polysaccharide with a hydrating solution to form a hydrated powder wherein said hydrating solution comprises:
water;
a hydratable polysaccharide;
a wetting agent selected from the group consisting of:
R¹—O—(R²)ₓ—R³
wherein:
R¹ is an alkyl 6-25 carbons, an aryl or combinations thereof;
each R² is independently selected from ethylene oxide, propylene oxide, or butylene oxide, in any order;
R³ is a terminal group; and
x is an integer of 1-9; and
pumping said fracturing solution into a well.

22. The method for subterranean fracturing of claim 21 wherein said hydratable polysaccharide is selected from the group consisting of anionically substituted galactomannan gum, guar and a cellulose derivative.

23. The method for subterranean fracturing of claim 22 wherein said hydratable polysaccharide is guar.

24. The method for subterranean fracturing of claim 21 wherein said hydratable polysaccharide is selected from the group consisting of anionically substituted guar gum, locust bean gum, guar gum derivatives, Karaya gum, carboxymethyl cellulose, carboxymethyl hydroxyethyl cellulose, and anionically substituted hydroxyethyl cellulose.

25. The method for subterranean fracturing of claim 24 wherein said hydratable polysaccharide is selected from the group consisting of carboxymethyl guar, carboxyethyl guar, carboxymethyl hydroxypropyl guar, carboxyethyl guar, carboxymethyl hydroxypropyl guar and carboxymethyl hydroxyethyl cellulose.

26. The method for subterranean fracturing of claim 24 wherein said hydratable polysaccharide is selected from the group consisting of sulfated or sulfonated guars, derivatized cationic guars, synthetic polymers with anionic groups.

27. The method for subterranean fracturing of claim 21 wherein said hydratable polysaccharide is selected from the group consisting of polyvinyl acetate, polyacrylamides and poly-2-amino-2-methyl propane sulfonic acid.

28. The method for subterranean fracturing of claim 21 wherein R¹ is an alkyl of 8-16 carbons.

29. The method for subterranean fracturing of claim 28 wherein R¹ is an alkyl of 10-14 carbons.

30. The method for subterranean fracturing of claim 21 wherein R³ is selected from H, an alkyl of 1-5 carbons and an aryl.

31. The method for subterranean fracturing of claim 21 wherein x is an integer of 3-5.

32. The method for subterranean fracturing of claim 21 wherein wetting agent is selected from the group consisting of ethoxylated hexyl alcohol with 2 to 9 EO groups, ethoxylated heptyl alcohol with 2 to 9 EO groups, ethoxylated octyl alcohol with 2 to 9 EO groups, ethoxylated nonyl alcohol with 2 to 9 EO groups, ethoxylated decyl alcohol with 2 to 9 EO groups, ethoxylated undecyl alcohol with 2 to 9 EO groups, ethoxylated dodecyl alcohol with 2 to 9 EO groups, ethoxylated tridecyl alcohol with 2 to 9 EO groups, ethoxylated tetradecyl alcohol with 2 to 9 EO groups, ethoxylated pentadecyl alcohol with 2 to 9 EO groups, ethoxylated hexadecyl alcohol with 2 to 9 EO groups, ethoxylated heptadecyl alcohol with 2 to 9 EO groups, ethoxylated octadecyl alcohol with 2 to 9 EO groups, ethoxylated nonadecyl alcohol with 2 to 9 EO groups, ethoxylated eicosyl alcohol with 2 to 9 EO groups, ethoxylated heneicosyl alcohol with 2 to 9 EO groups, ethoxylated docosyl alcohol with 2 to 9 EO groups, ethoxylated tricosyl alcohol with 2 to 9 EO groups, ethoxylated tetracosyl alcohol with 2 to 9 EO groups, ethoxylated pentacosyl alcohol with 2 to 9 EO groups and ethoxylated syrenated phenols.

33. The hydraulic fracturing solution of claim 21 further comprising a triglyceride.

34. The method for subterranean fracturing of claim 33 wherein said triglyceride is selected from a castor oil ethoxylate or a hydrogenated castor oil ethoxylate.

35. The method for subterranean fracturing of claim 21 further comprising a defoaming agent.

36. The method for subterranean fracturing of claim 35 comprising up to 0.10 wt % of said defoaming agent.

37. The method for subterranean fracturing of claim 35 wherein said defoaming agent is a polymer comprising at least one of polyethylene oxide or polypropylene oxide.

38. The method for subterranean fracturing of claim 37 wherein said defoaming agent has a molecular weight of at least 500 to no more than 6000.

39. The method for subterranean fracturing of claim 37 wherein said defoaming agent is a block copolymer.
